(19) United States
(12) Patent Application Publication
(10) Pub. No.: US 2002/0051521 A1
(43) Pub. Date: May 2, 2002

(54) Communication service with advertisement

(76) Inventor: R. Scott Patrick, Woodruff, SC (US)

Correspondence Address: John B. Hardaway III., Hardaway/Mann IP Group, PO Box 10107, Greenville, SC, 29603, US

(21) Appl. No.: 09/799,135

(22) Filed: Mar. 5, 2001

Related U.S. Application Data
(63) Continuation-in-part of application No. 09/697,794, filed on Oct. 27, 2000.

(51) Int. Cl. H04M 1/64

(52) U.S. Cl. 379/88.01

(57) ABSTRACT

Provided is a system for including an advertisement to a communication. The system comprises an exchange carrier capable of receiving information from a subscriber. The information comprises an initiation unit address, a destination unit address and a choice indicator. An interactive voice recognition module receives the information from the exchange carrier and forwards the initiation unit address to the profile server and forwards the choice indicator to an ad profile server. The profile server comprises at least one subscriber profile wherein the subscriber profile comprises the initiation unit address and at least one subscriber attribute for the subscriber. The ad profile server comprises at least two advertisements wherein each advertisement comprises at least one ad choice indicator and at least one ad attribute. At least one of the advertisements is the target advertisement wherein the ad choice indicator of the target advertisement and the choice indicator are the same and wherein the ad attribute of the target advertisement and the subscriber attribute are the same. The ad profile server transmits the target advertisement to the exchange carrier and the exchange carrier transmits the target advertisement to the subscriber for review by the subscriber. After the review the exchange carrier connects the subscriber to the destination unit address.

### RELATED APPLICATION

This application is related to, and claims priority to, U.S. patent appl. Ser. No. 09/697,794 filed Oct. 27, 2000 which is pending.

### BACKGROUND

A. Field of Invention

This invention pertains to a communication service which provides advertisements to subscribers. More particularly, this invention pertains to a communication service which provides advertisements to subscribers prior to connection to the receiving party.

B. Description of Related Art

The use of communication equipment such as telephones, computers modems and the like is now a widespread phenomenon which very few locations lack. As with any mature industry it is now incumbent upon the service providers to create new revenue streams in an effort to decrease the cost to the consumer while still maintaining operating profits which are sufficient for a sustainable business. One approach to reducing, or eliminating, the consumer cost for using communication channels is to sell unused, or available, time to advertisers. The advertisers can develop brand recognition during an activity wherein the consumer is typically waiting for a connection to be made with a telephone or internet service provider (ISP). Past efforts to accomplish this goal have met with limited success for reasons which the present invention corrects.

U.S. Pat. Nos. 4,850,007 and 5,448,625 allow subscribers to be relieved of some or all of their long distance billing for listening to various ads or marketing information. U.S. Pat. No. 5,448,625 inserts messages into the communication stream of a telephone conversation which would be annoying and disruptive. The frustration realized by a consumer who is having a conversation disrupted for an advertisement would override any positive influence the advertisement may otherwise have. U.S. Pat. No. 4,850,007 offers advertisements prior to connecting the line yet the consumer would likely ignore the advertisement and would instead focus on other activities around them instead of the message. This effect would be similar to that observed with television commercials which the viewer has no interest in viewing. A result of the present state of the art is an ineffective telephone advertising system which has heretofore met with limited success.

Advertising over Digital Subscriber Lines is an equally challenging problem. Various pop-up type ads have been provided by many connection service providers but the consumer factors the advertisement into the allotted time for logging onto a system and essentially ignores the message unless it is of specific interest at the time of viewing. Flashing pictures, sounds and other techniques to attract attention have limited success.

Fee based services are becoming more abundant in communication. These include such services as caller ID, call waiting, etc. All of these are under pressure to reduce the cost to the consumer in a manner analogous to the connection charge. Advertising incorporated into these specific services would provide some relief for the consumer yet the same problem of capturing the consumers interest remains.

### SUMMARY

It is an object of the present invention to provide an advertisement system which can be incorporated into a communication device and which will allow consumer selectable advertising to increase consumer awareness and interest in the advertising content.

It is another object of the present invention to provide an advertising system which can be incorporated into an existing communication network with minimal alterations to the network and with a minimal capital equipment requirement.

A particular feature of the present invention is the ability to apply the invention to digital systems, such as a computer network, or to telephone systems.

These and other advantages, as will be realized from the disclosure herein, are provided in a system for attaching a target advertisement to a communication. The system comprises an exchange carrier capable of receiving information from a subscriber. The information comprises an initiation unit address, a destination unit address and a choice indicator. An interactive voice recognition module receives the information from the exchange carrier and forwards the initiation unit address to the profile server and forwards the choice indicator to an ad profile server. The profile server comprises at least one subscriber profile wherein the subscriber profile comprises the initiation unit address and at least one subscriber attribute for the subscriber. The ad profile server comprises at least two advertisements wherein each advertisement comprises at least one ad choice indicator and at least one ad attribute. At least one of the advertisements is the target advertisement wherein the ad choice indicator of the target advertisement and the choice indicator are the same and wherein the ad attribute of the target advertisement and the subscriber attribute are the same. The ad profile server transmits the target advertisement to the exchange carrier and the exchange carrier transmits the target advertisement to the subscriber for review by the subscriber. After the review the exchange carrier connects the subscriber to the destination unit address.

Another embodiment is provided in a system for attaching a target advertisement to a communication. The exchange carrier receives information from a subscriber wherein the information comprises an initiation unit address, a destination unit address and a choice indicator. An ISP receives the information from the exchange carrier and forwards the initiation unit address to a profile server and the choice indicator to an ad profile server. The profile server comprises at least one subscriber profile wherein the subscriber profile comprises the initiation unit address and at least one subscriber attribute. The ad profile server comprises at least two advertisements wherein each of the advertisements comprises at least one ad choice indicator and at least one ad attribute. At least one of the advertisements is the target advertisement wherein the ad choice indicator of the target advertisement and the choice indicator are the same and wherein the subscriber attribute and the ad attribute of the target advertisement are the same. The ad profile server transmits the target advertisement to the exchange carrier and the exchange carrier transmits the target advertisement to the subscriber for review. After reviewing the advertisement the subscriber is connected to the destination unit address.

Yet another embodiment is provided in a system for attaching a target advertisement to a communication. The system comprises a message server capable of receiving information from a subscriber. The information comprises an initiation unit address, a destination unit address and a choice indicator. The message server further comprises at least one subscriber profile wherein the subscriber profile comprises the initiation unit address and at least one subscriber attribute. The message server further comprises at least two advertisements wherein each advertisement comprises at least one ad choice indicator and at least one ad attribute and at least one of the advertisements is the target advertisement wherein the ad choice indicator of the target advertisement and the choice indicator are the same and wherein the ad attribute of the target advertisement and the subscriber attribute are the same. The message server sends the target advertisement to the subscriber for a review and after the review an exchange carrier connects the subscriber to the destination unit address.

Yet another embodiment is provided in a system for attaching a target advertisement to a communication. The system comprises a profile server capable of receiving information from a subscriber. The information comprises an initiation unit address, a destination unit address and a choice indicator. The profile server further comprises at least one subscriber profile wherein the subscriber profile comprises at least one subscriber attribute for the subscriber. The system further comprises an ad profile server comprising at least two advertisements wherein each of the advertisements comprises at least one ad choice indicator and at least one ad attribute. At least one of the advertisements is the target advertisement wherein the ad choice indicator of the target advertisement and the choice indicator are the same and wherein the ad attribute of the target advertisement and the subscriber attribute are the same. The profile server transmits the target advertisement to the subscriber for a review by the subscriber. After the review an exchange carrier connects the subscriber to the destination unit address.

### BRIEF DESCRIPTION OF THE DRAWINGS

FIG. 1 illustrates diagrammatically a telephone network as used for a communication being placed over the telephone network in cooperation with the present invention.

FIG. 2 is a flow diagram of the embodiment of FIG. 1.

FIG. 3 illustrates diagrammatically a network associated with a consumer communicating over the network in cooperation with the present invention.

FIG. 4 is a flow diagram of the embodiment of FIG. 3.

FIG. 5 illustrates diagrammatically a telephone network as used for a communication being routed through an ad server.

FIG. 6 illustrated diagrammatically a telephone network comprising a peripheral ad server.

FIG. 7 illustrates diagrammatically a network associated with an internet connection.

### DETAILED DESCRIPTION

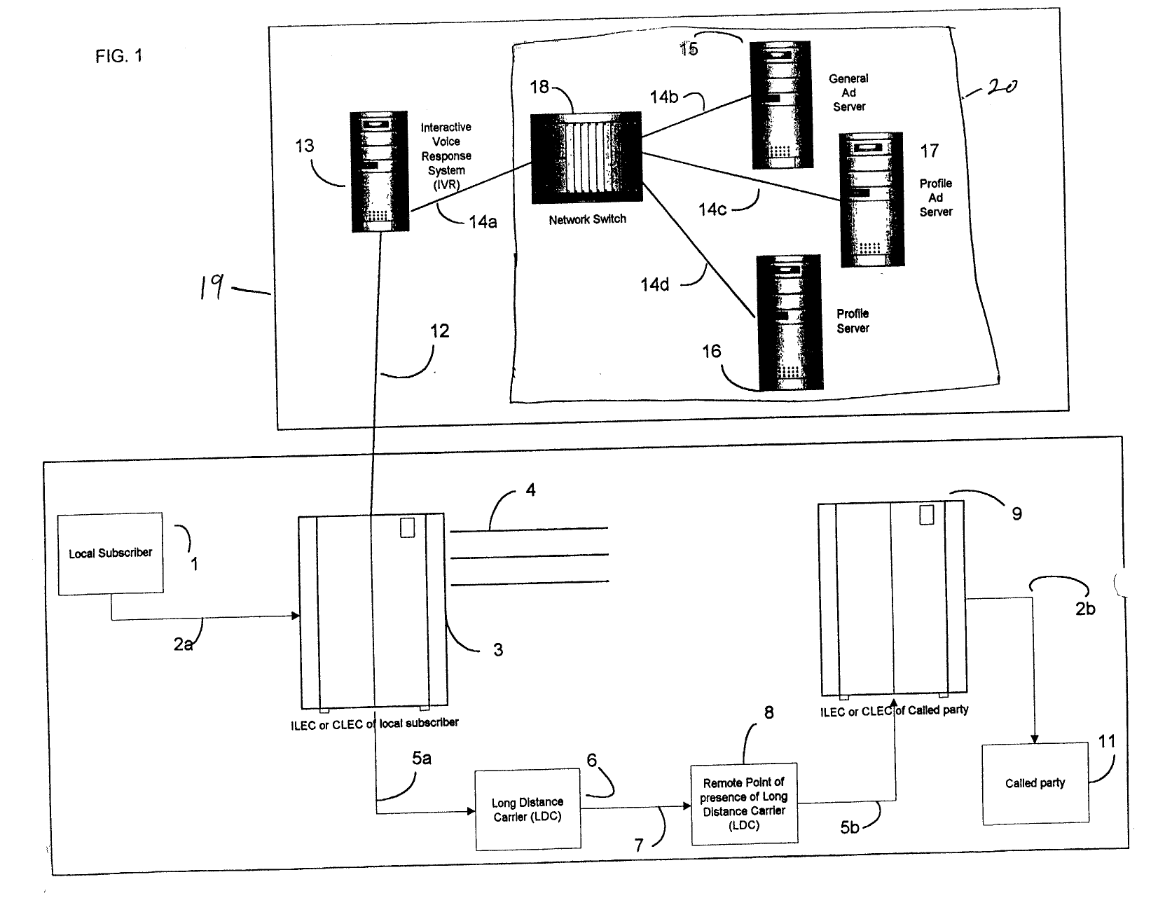

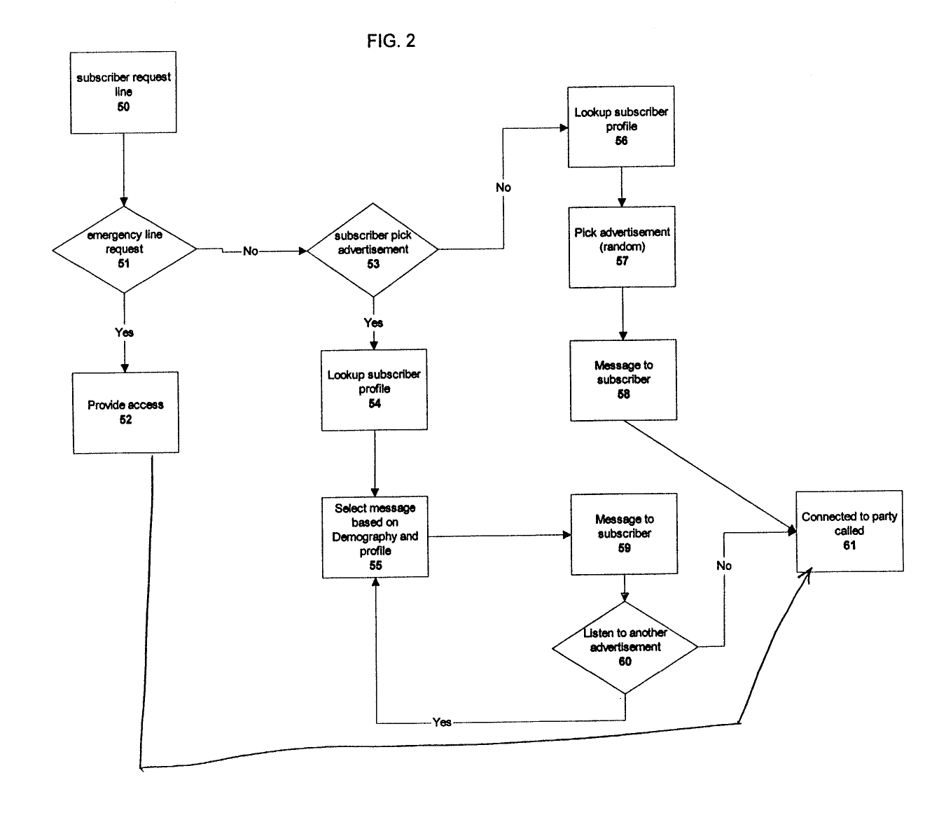

FIG. 1 illustrates the components required for a consumer to place a call and the route the call would take to get to the called party. The flow diagram in FIG. 2 explains how the process would progress. This flow diagram illustrates what happens when the subscriber picks up the phone and requests calling priviledges. In step 50, the exchange carrier, 3, receives a request from the subscriber, 1, for a dial tone over linkage 2a. The request preferably includes the phone number of the subscriber which is referred to as the initiation unit address. The subscriber represents an analog telephone or a digital input device such as a digital telephone or a computer with an associated connection device such as a modem. The subscriber, 1, enters the digits corresponding to the destination unit address, preferably a phone number, of the called party, 11. In the case of an emergency number such as 911 or 0 the call would be allowed to bypass the advertisements as indicated at step 51, and the call would proceed directly to step 52 wherein access would be provided and the call connected at step 61. If the digits entered differ from an emergency number the call would proceed through the exchange carrier, 3, and the call would continue by passing to an interactive voice response system (IVR), 13, of a message server, 19, via linkage 12. The subscriber would then be prompted to choose among a preselected set of advertisements which the subscriber is interested in at step 53 by entering a choice indicator. In an alternate embodiment the choice indicator can be automatically supplied by the telephone, digital input device or computer. The IVR, 13, passes the subscribers dialing digits through a network switch, 18, to a profile server, 16, through linkages, 14a and 14d. The profile server, 16, which contains subscriber profiles, obtains a subscriber profile at step 54 for the subscriber and forwards the subscriber profile to the profile ad server, 17, which comprises advertisements. Each advertisement comprises an ad choice indicator and an ad attribute. The adverstisements are preferably 5 seconds to 1 minute in duration and more preferably 5-30 seconds in duration. The profile ad server, 17, selects at least one target advertisement which has an ad choice indicator which is the same as the choice indicator entered by the subscriber at step 55. Alternatively, the profile ad server, 17, selects those advertisements that are encompassed by the choice indicator. Once selected, the target advertisement is sent from the profile ad server, 17, to the subscriber, 1, through the network switch, 18, via linkages 14da and 14c as indicated at step 59. The profile ad server, 17, will send the subscriber as many target advertisements as desired. After each target advertisement is reviewed the subscriber is offered the opportunity to listen to another advertisement as indicated at step 60. If an affirmative response is given at step 60 a new target advertisement is selected at step 55 and the profile ad server, 17, sends the new target ad to the subscriber, 1. If a negative answer is given at step 60 the advertisements are terminated. In another embodiment the subscriber may be connected to the advertisement wherein further information can be obtained, reservations made or other information can be obtained. After the communication with the advertiser ceases the subscriber would be connected to the called party. If the subscriber chooses to terminate receiving advertisements and instead chooses to connect to the called party, 11, the exchange carrier, 3, checks to determine if the call is local or long distance. If the call is local the exchange will send the call through other local offices, 4, if necessary. If the call is long distance the exchange carrier, 3, will send the call over the linkage, 5a, of the long distance carrier of choice to the long distance carriers local point of presence, 6, then through the long distance carrier network linkage, 7, and finally to the long distance carriers remote point of presence, 8. The call is then sent to the called party exchange carrier, 9, over linkages, 5b, and the call is forwarded to the called party, 11, at the destination unit address over linkage 2b.

If the subscriber does not choose an advertisement at step 53 the IVR system, 13, will send the request through the network switch, 18, to the profile server, 16, via linkages 14a and 14d. The profile server, 16, updates and obtains a subscriber profile at step 56 and sends the information back through the network switch, 18, to a general ad server, 15, via linkages 14d and 14b. A random message is selected at step 57 from the general ad server, 15. After reviewing the random advertisement, which the subscriber receives at step 58, the subscriber is connected to the called party at step 61.

It would be understood to those skilled in the art that the network switch, 18, may be combined with any combination of the general server, 15, profile ad server, 17, and profile server, 16, and in a particularly preferred embodiment an ad server, 20, comprising a network switch, general ad server, profile ad server and profile server may be employed. It is also understood that the function of the general ad server and profile ad server could be incorporated into a single server without departing from the scope of the present invention. For the purposes of illustration and clarity the servers are illustrated as separate herein to insure that the functions are fully disclosed.

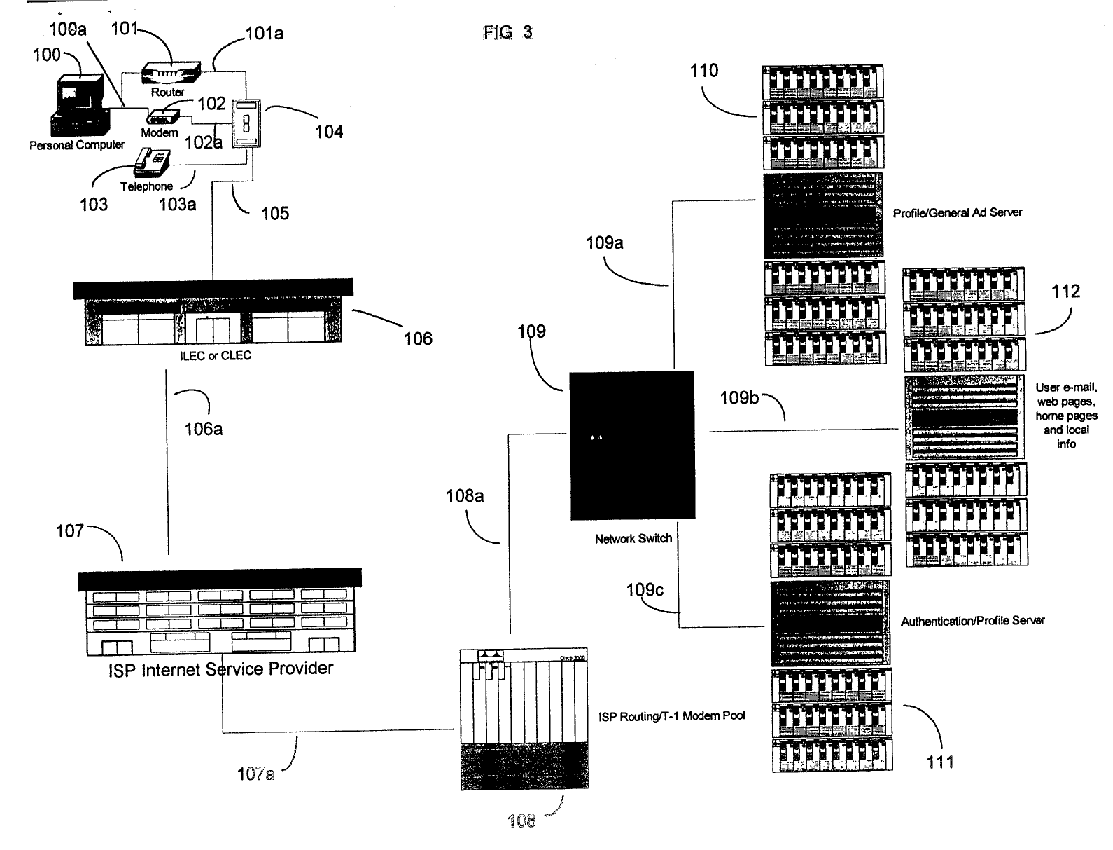

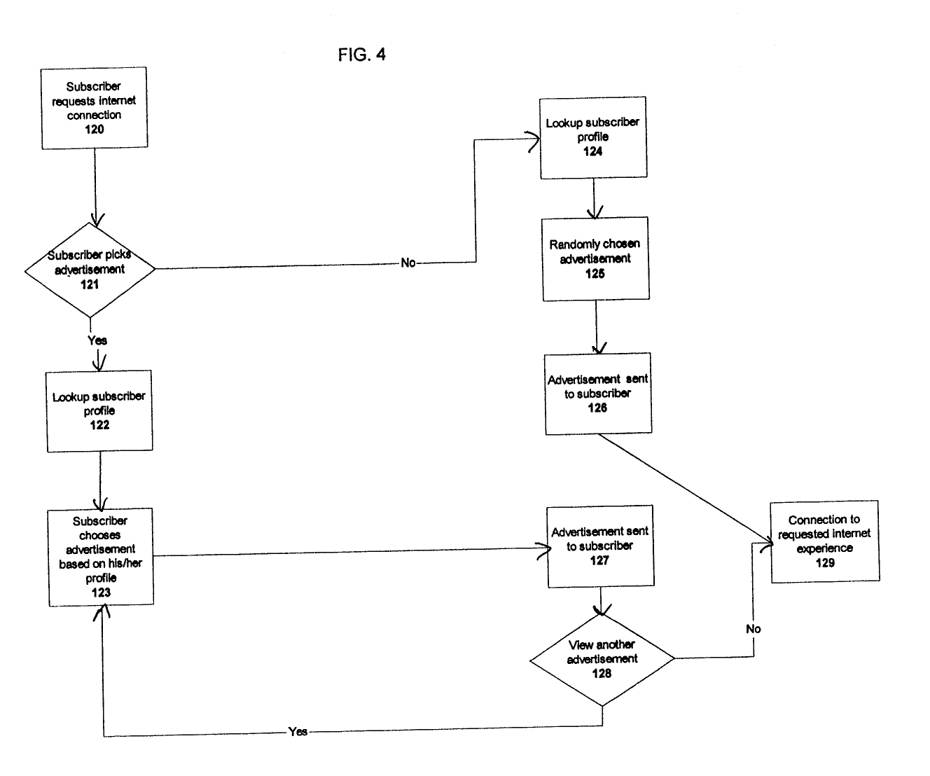

FIG. 3 illustrates the components associated with a subscriber initiating a digital subscriber line (DSL) connection to an internet session or a similar session over a network. FIG. 4 is a flow diagram indicating the steps associated with the process illustrated in FIG. 3. In step 120, the subscriber is preferably a personal computer, 100, which transmits signals through linkage 100a to an interface such as a modem 102 or a hub/router 101. The signal comprises the initiation unit address, the destination unit address and a choice initiator and may be sent as a continuous stream of data or sent sequentially in response to queries. The initiation unit address and destination unit address are preferably a computer address or node address. The interface sends the signal through the linkage 101a or 102a to the exchange carrier, 106, through linkage 105. It is most common to have a connection port, 104, such as a wall plate or similar device connecting the linkages. The exchange carrier, 106, sends the signal to an internet service provider (ISP), 107, connected via linkage, 106a. Bandwidth ranges for the ISP connection are normally 10-100 Mbps, OC3 or OC45. In an alternate embodiment the ISP, 107, and exchange carrier, 106, could be one entity or combined into one physical unit. The ISP and exchange carrier are illustrated as separate herein to illustrate the function of each and the role each function plays in the operation of the invention. Once the signal reaches the ISP, 107, the signal is sent through the ISP network linkage, 107a, via routing equipment, 108, to a network switch, 109, to the authentication server, 111, via linkages 108a and 109c. The subscriber supplies a tag element such as a name, initiation unit address, identification code, password, or similar input which is either supplied by responding to a prompt or is stored in the computer, 100, and provided automatically when prompted.

At step 121, the subscriber enters a choice indicator which will correspond with a specific target advertisement, group of target advertisements or a target advertisement category. If the subscriber decides not to enter a choice indicator an advertisement will be chosen based on the subscriber profile stored in the authentication server, 111, which is retrieved as indicated at step 124. The subscriber profile is sent to the profile/general ad server 110, through the network switch 109, via linkages 109a and 109c. A random advertisement is chosen at step 125 based on the subscriber profile. The advertisement is then sent to the subscriber at step 126. After the advertisement has scrolled for a predetermined time, or when the subscriber has closed the advertisement upon its completion, the subscriber is then connected to the internet experience at step 129 or to the email system or home page computer, 112. It is preferable that the advertisement scrolls for 5 seconds to 1 minute. More preferably the advertisement scrolls for 5-30 seconds and most preferably the advertisement scrolls for 5-15 seconds. The home page computer, 112, receives the information from the profile/general ad server, 110, through the network linkage, 109a, the network switch, 109, and linkage 109b.

If the subscriber enters a choice indicator, at step 121, the subscriber profile is retrieved from the authentication server, 111, as indicated at step 122 and transmitted to the profile/general ad server, 110. The profile/general ad server, 110, retrieves a target advertisement at step 123 based on the choice indicator and subscribers profile. When this is accomplished, the profile/general ad server, 110, transmits the target advertisement to the subscriber through the network switch, 109, ISP, 107, and exchange carrier, 106, via associated linkages at step 127. After viewing the target advertisement the subscriber has the opportunity to view another target advertisement at step 128, or be connected to the internet experience at step 129, in which case the subscriber is connected to the home page computer, 112, at the destination unit address.

In a particularly preferred embodiment the subscriber may select to proceed to the home web page corresponding to the advertisement by clicking on an icon as well recognized in the art.

The advertisements stored in the profile/general ad server, 110, each comprise at least one ad choice indicator and at least one ad attribute. The ad choice indicator is compared to the choice indicator entered by the subscriber and the ad attribute is used to compare with the attribute of the subscriber.

In another embodiment, the subscriber accesses the exchange carrier, 106, via a digital telephone, 103, connected to the exchange carrier by linkages 103a and 105 with an optional connection port 104 situated therebetween. The digital telephone transmits an initiation unit address, a destination unit address and choice indicators to the exchange carrier. The initiation unit address is preferably a phone number.

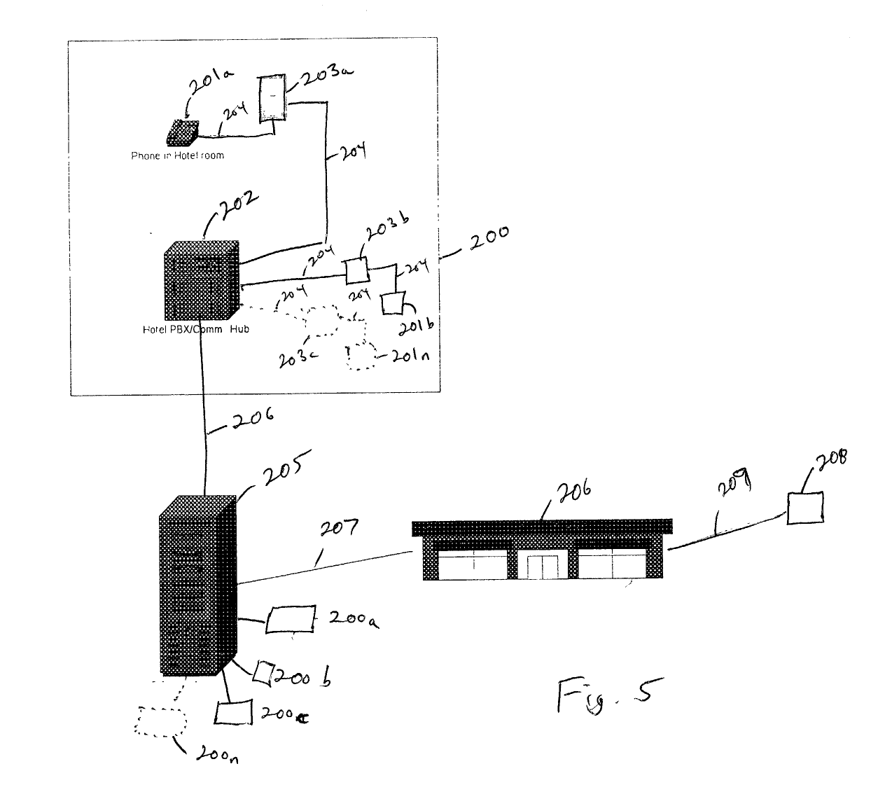

Another embodiment is illustrated diagrammatically in FIG. 5. In FIG. 5 a user group, 200, comprises a multiplicity of subscribers, 201. Each subscriber connects to a router, or hub, 202, though an optional, but preferred, communication port, 203, with appropriate communication link, 204. The hub transmits information to an ad server, 205, through an appropriate communication link, 206. The ad server, 205 may service a multiplicity of user groups, 200a-200n, wherein each user group may further comprise a multiplicity of subscribers. The information comprises an initiation address, a destination address and a subscriber attribute. The ad server, 205, comprises a multiplicity of ads wherein each ad comprises an ad attribute. The ad server, 205, transmits the destination address to an exchange carrier, 206, via an appropriate communication link, 207, whereby the subscriber of the user group is connected to the called party, 208, via an appropriate communication link, 209.

In the embodiment illustrated in FIG. 5, the subscriber, 201, of the user group, 200, makes a request for a communication by lifting a phone receiver and dialing a number or an access number to a called party, 208. The called party may represent another subscriber of the same user group, a different user group, or may be outside of the user group. For the purposes of clarity the operation will be described for a called party outside of the user group with the understanding that other called parties would be within the scope of the present invention. The hub, 202, receives the request and forwards a subscriber attribute to the ad server, 205. The subscriber attribute may be supplied by the subscriber or the hub. The ad server transmits an advertisement to the hub, 202, and the hub transmits the advertisement to the subscriber. The ad server initiates connection of the communication with the exchange carrier, 206, whereby the communication between the subscriber and the called party, 208, is complete. In one embodiment the ad server initiates the communication with the exchange carrier prior to transmitting the advertisement and the advertisement is reviewed during the time required to connect the communication link between the subscriber and the called party. In another embodiment, the ad server may transmit an advertisement and initiate the communication with the exchange carrier after the advertisement has terminated or canceled by command of the subscriber. In this embodiment the subscriber may be offered an option to connect directly with the advertiser by entering a command or by response to a prompt. The subscriber may then be able to obtain additional information, make reservations or otherwise communicate with the advertiser. After the communication with the advertiser is complete the communication with the exchange carrier is initiated. The user group includes groups of subscribers such as an office complex, hotel, motel, neighborhood, or other associated groups.

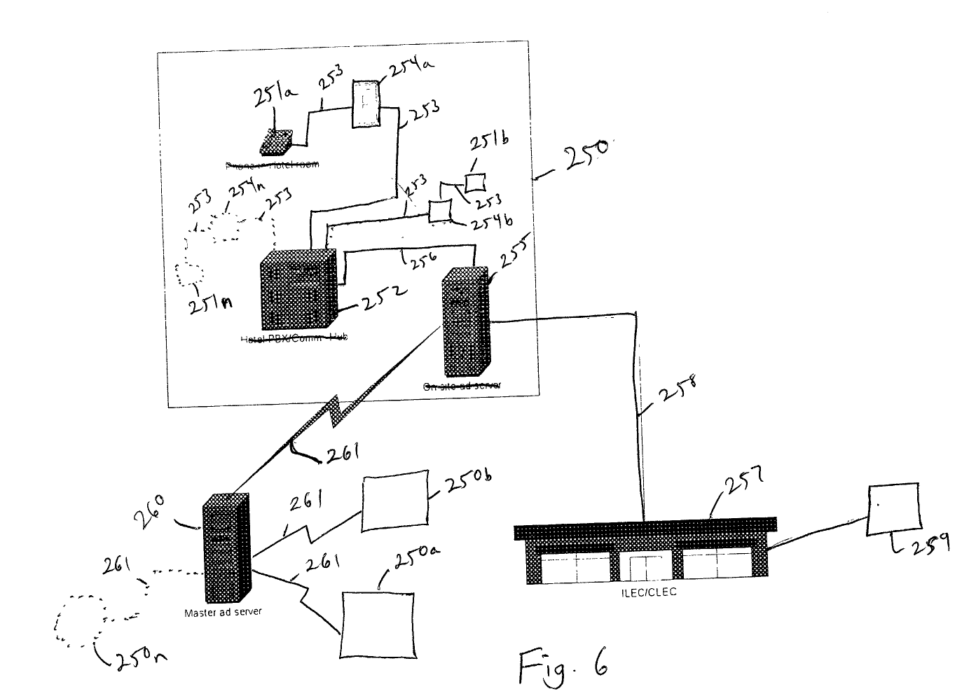

Another embodiment is illustrated diagrammatically in FIG. 6. A user group, 250, such as an office complex, hotel, motel, neighborhood, or other associated group comprises a multiplicity of subscribers, 251. Each subscriber is connected to a hub, 252, by an appropriate communication link, 253, and optional, but preferred, communication port, 254. The hub receives a request for a communication link from the subscriber and transmits information to a server, 255, via an appropriate communication link, 256. The information comprises a destination unit address and a subscriber attribute. The server, 255, transmits the destination unit address to an exchange carrier, 257, via an appropriate communication link, 258. The exchange carrier connects the subscriber to the called party, 259. The server, 255, transmits an advertisement wherein the advertisement comprises an ad attribute which corresponds to the subscriber attribute. An ad server, 260, connected via an appropriate communication link, 261, updates the server, 255, on some frequency such that the ad server has the appropriate advertisements. The subscriber may review the advertisement prior to the server connecting to the exchange carrier or the subscriber may review the advertisement during the time required for the exchange carrier to create a connection between the subscriber and the called party. The ad server, 260, may provide advertisements for a multiplicity of user groups, 250a-n, wherein each user group may further comprise subscribers.

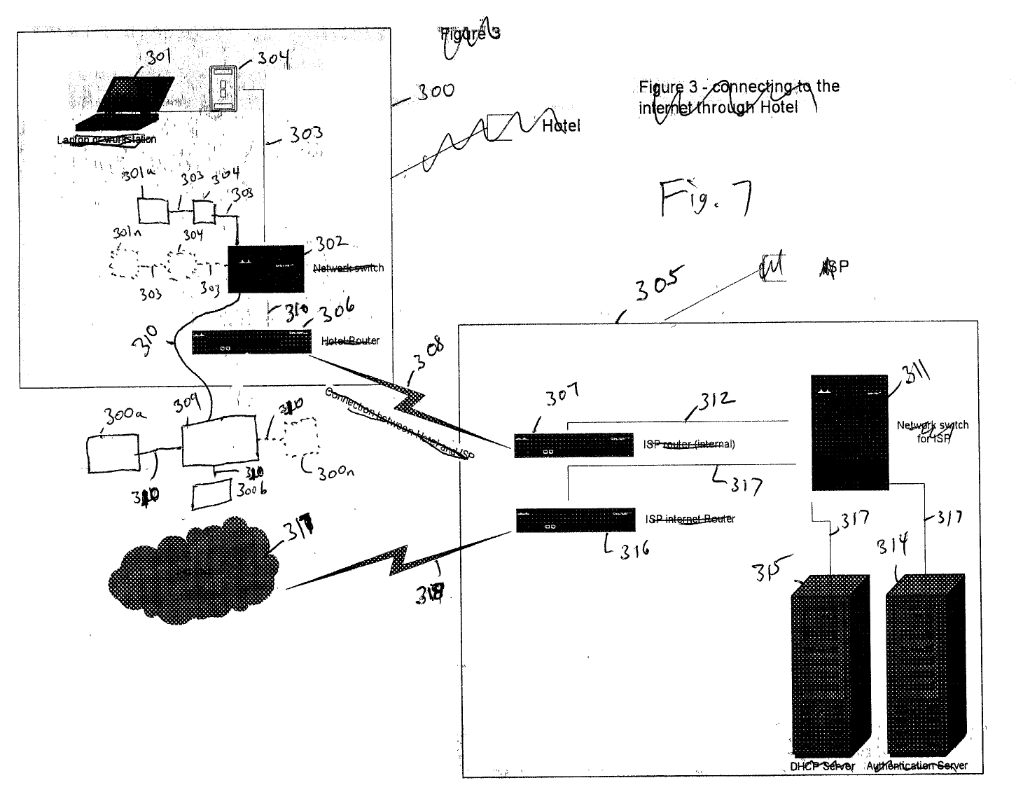

Another embodiment is illustrated diagrammatically in FIG. 7. In FIG. 7, a user group, 300, such as an office complex, hotel, motel, neighborhood, or other associated group comprises a multiplicity of subscribers, 301, wherein each subscriber is connected to a network switch, 302, via an appropriate communication link, 303, and optional communication port, 304. The subscriber request a connection to an internet service provider (ISP), 305. The request is routed from the network switch, 302, to a user group router, 306. The user group router, 306, communicates with an ISP router, 307, which is associated with the ISP, 305. The user group router and ISP router communicate via an appropriate communication link, 308. The network switch, 302, transmits a subscriber attribute to an ad server, 309, via an appropriate communication link, 310. The ad server, 309, transmits an advertisement wherein the advertisement comprises an ad attribute which corresponds to the subscriber attribute supplied to the ad server. The ad server, 309, may communicate with multiple user groups, 300a-n, wherein each user group may further comprise a multiplicity of subscribers. The ISP typically comprises a ISP router, 307, which communicates with a ISP network switch, 311, via an appropriate communication link, 312. The ISP network switch, 311, communicates with various servers, 314 and 315, and an internet router, 316, to connect the subscriber to the internet, 317, via appropriate communication linkages, 318. The user group router, 306, may transmit an advertisement to the subscriber prior to communicating with the ISP, 305, or the user group router, 306, may transmit an advertisement to the subscriber during the time period required for a communication link between the subscriber and the ISP to be established. The user group router may also transmit advertisements during the time that the communication link between the subscriber and ISP is occurring such as during a period of minimal transmission of information as typically occurs when messages are being typed or read.

The various components of the invention can be connected or linked by any linkage method known in the arts of relaying information between components of a network. Particularly preferred are linkages which are known for transmitting information including cables, wires, fiber optic lines or various carrier waves such as microwave, infrared, radio frequency and the like. The linkage may involve components which are not listed herein for brevity but understood to be utilized in the art such as satellites, repeater stations, routers and the like.

The exchange carrier is typically a local telephone service which receives information from a telephone or modem via a transmission linkage and transmits the information. The exchange carrier is preferably an Incumbent Local Exchange Carrier (ILEC) or Competitive Local Exchange Carrier (CLEC).

The interactive voice response system converts tones to digital signals. The tones may be tones uttered by a person, such as a spoken command, or tones associated with the keys of a telephone wherein each key has a tone which is distinguishable from the other keys. For the purposes of the present invention a Model E60 500-600 MHz, with Pentium processors, from Hewlett Packard is adequate for demonstrating the effectiveness of the present invention particularly when small networks are used. Model LC2000 667 MHz-1 Ghz, with Pentium processors, from Hewlett Packard is adequate for demonstrating the effectiveness of the present invention when medium size networks are used. For large networks Model LH6000, with Xeon processors (700 MHz) from Hewlett Packard is adequate for demonstrating the present invention. The distinction between small, medium and large is not limiting but one of the three listed preferred systems can be selected by one skilled in the art based on cost, efficiency and other parameters. It is preferred that the IVR would be configured with at least a 9 or 18 gigabit hard drive and random access memory commensurate with the task.

Network switches are well known and commercially available from a variety of sources. In general, a network switch directs information from an input source to an output source based on preselected criteria or criteria which is included within the information being transmitted. While not limited thereto a particularly suitable network switch is Cisco Catalyst 4003.

The servers are preferably a non-volatile storage device which can maintain information with, or without, power. The servers are typically a combination of read-only-memory chips which are unaltered in use and storage media which can be altered by commands from input including the information supplied by the subscriber in the present invention. Particularly preferred servers comprise digital drives. It is common to move information from program storage devices to random-access-memory devices within the server during use to expedite the rate at which calculations or information transmittal occurs. Preferred storage media allow data to be selected from any point on the device such as is common with compact disk technology, magnetic disk technology, random access memory technology and the like. Typical examples include compact disk juke boxes and the like which are commercially available. Sequential data storage techniques such as magnetic tape are less desirable since the access time is longer. Methods enabling the storage of redundant information to protect against loss of service in the event of failure by one storage media are particularly preferred.

Modems and hub routers are well known in the industry and further elaboration of the details is not necessary for full disclosure of the invention. A US Robotics 33.6 external modem is particularly well suited for demonstrating the present invention but any modem commonly used to connect a computer to a network is suitable. Hub routers are well known and the choice of a hub router is not limited herein. A particularly suitable hub router is Cisco Catalyst 4006.

Broadly speaking, the internet, or computer network, is a set of communication devices, or nodes, and communication links which interconnect the communication devices. The communication devices are typically computers, terminals, workstations, or other similar devices capable of receiving and/or sending data. Each communication device is capable of residing at vastly different geographical locations if so desired. The communication links between communication devices are typically, but not limited to, a combination of transmission devices such as optical fibers, coaxial cable, twisted copper pairs or terrestrial signals relayed by satellites and/or antennas. Most commonly the communication link is a wide area network (or “WAN”), such as the internet or world wide web. The communication link uses either public or private switching systems to form the communication linkages between various communication devices. The communication linkage is typically maintained and managed by internet service providers who provide communication nodes whereby clients can link to the network through the communication node of the service provider.

The choice indicator can be entered in various ways known in the art. A pull-down menu can be provided with the subscriber having the ability to select between various choice indicators. Key words may be entered wherein the key word is used as a search term in the advertisements. A numbering system can be used wherein certain numbers correspond to certain classes of advertisements such as automobile, housing etc. The choice indicator may also be entered automatically, or stored by, the phone or computer and include such information as time, location within a subscriber environment, etc.

The ad attributes are selected such that target advertisements are suitable for the subscriber. For example, the attribute may define a geographic region to insure that the target advertisements presented are in the same geographic region as the subscriber. Other attributes may include sex, age, occupation, hobbies, income level, etc. Throughout the specification the ad attribute and subscriber attribute are compared. The ad attribute and subscriber attribute are considered to be the same when the ad attribute is a species of the subscriber attribute genus or when the subscriber attribute is a species of the ad attribute genus. For example a subscriber attribute of “transportation” maybe the same as ad attributes train, auto, air, etc. A subscriber attribute of “auto” maybe the same as ad attributes transportation.

It would be understood to one skilled in the art that the various components and functions described herein could be achieved in many ways without departing from the scope of the invention. It is particularly contemplated that a skilled artisan could combine certain elements of the present invention or separate certain elements to optimize for communication rate or cost without departing from the scope of the present invention which is defined in the claims which follow.

What is claimed is:

1. A system for attaching a target advertisement to a communication comprising:
an exchange carrier capable of receiving information from a subscriber wherein said information comprises an initiation unit address, a destination unit address and a choice indicator;
an interactive voice recognition module capable of receiving said information from said exchange carrier and forwarding said initiation unit address to a profile server and forwarding said choice indicator to an ad profile server;
said profile server comprises at least one subscriber profile wherein said subscriber profile comprises said initiation unit address and at least one subscriber attribute for said subscriber;
said ad profile server comprises at least two advertisements wherein each of said advertisements comprises at least one ad choice indicator and at least one ad attribute and wherein said at least one of said advertisements is said target advertisement wherein said ad choice indicator of said target advertisement and said choice indicator are the same and wherein said ad attribute of said target advertisement and said subscriber attribute are the same; and
wherein said ad profile server transmits said target advertisement to said exchange carrier and said exchange carrier transmits said target advertisement to said subscriber for a review by said subscriber and after said review said exchange carrier connects said subscriber to said destination unit address.

2. The system of claim 1 wherein said subscriber is a telephone.

3. The system of claim 1 wherein said subscriber is a computer.

4. The system of claim 1 further comprising a network switch situated to receive said initiation unit address from said interactive voice recognition module and routing said initiation unit address to said profile server and said network switch is capable of receiving said choice indicator from said interactive voice recognition module and routing said choice indicator to said profile server.

5. The system of claim 4 comprising an ad server wherein said ad server comprises said network switch, said profile server and said ad profile server.

6. A system for attaching a target advertisement to a communication comprising:
an exchange carrier capable of receiving information from a subscriber wherein said information comprises an initiation unit address, a destination unit address and a choice indicator;
an ISP capable of receiving said information from said exchange carrier and forwarding said initiation unit address to a profile server and said choice indicator to an ad profile server;
said profile server comprises at least one subscriber profile wherein said subscriber profile comprises said initiation unit address and at least one subscriber attribute;
said ad profile server comprises at least two advertisements wherein each of said advertisements comprises at least one ad choice indicator and at least one ad attribute and wherein at least one of said advertisements is said target advertisement wherein said ad choice indicator of said target advertisement and said choice indicator are the same and wherein said subscriber attribute and said ad attribute of said target advertisement are the same; and
wherein said ad profile server transmits said target advertisement to said exchange carrier and said exchange carrier transmits said target advertisement to said subscriber for a review and after said review said subscriber is connected to said destination unit address.

7. The system of claim 6 wherein said subscriber is a computer.

8. The system of claim 7 wherein said computer connects to said exchange carrier by a modem.

9. The system of claim 7 wherein said computer connects to said exchange carrier by a hub router.

10. The system of claim 6 wherein said subscriber is a digital telephone.

11. A system for attaching a target advertisement to a communication comprising:
a message server capable of receiving information from a subscriber wherein said information comprises an initiation unit address, a destination unit address and a choice indicator and said message server comprises at least one subscriber profile wherein said subscriber profile comprises said initiation unit address and at least one subscriber attribute;
said message server further comprises at least two advertisements wherein each of said advertisements comprises at least one ad choice indicator and at least one ad attribute and wherein said at least one of said advertisements is said target advertisement wherein said ad choice indicator of said target advertisement and said choice indicator are the same and wherein said ad attribute of said target advertisement and said subscriber attribute are the same; and
wherein said message server sends said target advertisement to said subscriber for a review by said subscriber and after said review said subscriber is connected to said destination unit address.

12. The system of claim 11 wherein said message server comprises a profile server, and a profile ad server.

13. The system of claim 11 further comprising an exchange carrier capable of receiving said information from said subscriber and transmitting said information to said message server.

14. The system of claim 11 further comprising an internet service provider capable of receiving said information from said subscriber and transmitting said information to said message server.

15. The system of claim 13 further comprising an internet service provider capable of receiving said information from said exchange carrier and transmitting said information to said message server.

16. A system for attaching a target advertisement to a communication comprising:
a profile server capable of receiving information from a subscriber wherein said information comprises an initiation unit address, a destination unit address and a choice indicator wherein said profile server comprises at least one subscriber profile and wherein said subscriber profile comprises at least one subscriber attribute of said subscriber;
an ad profile server comprising at least two advertisements wherein each of said advertisements comprises at least one ad choice indicator and at least one ad attribute and wherein said at least one of said advertisements is said target advertisement wherein said ad choice indicator of said target advertisement and said choice indicator are the same and wherein said ad attribute of said target advertisement and said subscriber attribute are the same; and
wherein said profile server transmits said target advertisement to said subscriber for a review by said subscriber and after said review said subscriber is connected to said destination unit address.

17. The system of claim 16 wherein said profile server receives said information through an exchange carrier.

18. The system of claim 17 further comprising a network switch situated to receive said initiation unit address from said exchange carrier and routing said initiation unit address to said profile server and said network switch is capable of receiving said choice indicator from said exchange carrier and routing said choice indicator to said profile server.

19. The system of claim 16 wherein said profile server receives said information through an internet service provider.

20. The system of claim 19 further comprising a network switch situated to receive said initiation unit address from said internet service provider and routing said initiation unit address to said profile server and said network switch is capable of receiving said choice indicator from said internet service provider and routing said choice indicator to said profile server.

21. A system for incorporating advertisements in a communication comprising:
an ad server comprising an advertisement wherein said advertisement comprises an ad attribute;
a user group comprising at least one subscriber;
said ad server receives information from said user group wherein said information comprises a destination unit address requested by said subscriber and a subscriber attribute; and
said ad server transmits said advertisement to said subscriber and connects said subscriber to an exchange carrier wherein said exchange carrier connects said subscriber to said destination unit address wherein said ad attribute and said subscriber attribute are the same.

22. The system of claim 21 further comprising multiple user groups wherein said ad server receives said information from said user groups.

23. The system of claim 21 wherein said choice indicator is provided by said subscriber.

24. The system of claim 21 wherein said ad server transmits said advertisement prior to connecting said subscriber to said exchange carrier.

25. A system for incorporating advertisements in a communication comprising:
a server;
an ad server comprising an advertisement wherein said advertisement comprises an ad attribute;
a user group comprising at least one subscriber;
said server receives information from said user group wherein said information comprises a destination unit address requested by said subscriber and a subscriber attribute;
said server transmits said subscriber attribute to said ad server and said ad server transmits said advertisement to said subscriber wherein said ad attribute and said subscriber attribute are the same;
said server connects said subscriber to an exchange carrier wherein said exchange carrier connects said subscriber to said destination unit address.

26. A system for incorporating advertisements in a communication comprising:
a server;
an ad server comprising an advertisement wherein said advertisement comprises an ad attribute;
a user group comprising at least one subscriber;
said server receives information from said user group wherein said information comprises a destination unit address requested by said subscriber and a subscriber attribute;
said server transmits said subscriber attribute to said ad server and said ad server transmits said advertisement to said subscriber wherein said ad attribute and said subscriber attribute are the same;
said server connects said subscriber to an internet service provider wherein said exchange carrier connects said subscriber to said destination unit address.
